(19) United States
(12) Patent Application Publication
(10) Pub. No.: US 2026/0241537 A1
(43) Pub. Date: Aug. 20, 2026

(54) WORKPIECE CARRIER AND WORKPIECE-CARRIER SYSTEM

(71) Applicant: ZELL Systemtechnik GmbH, Ehingen-Volkersheim (DE)

(72) Inventor: Ingo ZELL, Ehingen-Volkersheim (DE)

(73) Assignee: ZELL Systemtechnik GmbH, Ehingen-Volkersheim (DE)

(21) Appl. No.: 18/713,258

(22) PCT Filed: Dec. 8, 2022
(86) PCT No.: PCT/EP2022/085018

§ 371 Date: May 24, 2024

(30) Foreign Application Priority Data
Dec. 8, 2021 (DE) 10 2021 132 309.6

(51) Int. Cl. B25H 1/08

(52) U.S. Cl. CPC B25H 1/08

(57) ABSTRACT

A workpiece carrier has a carrier base and at least one variable-height handle, which includes a crosspiece and two legs and is detachably secured to the carrier base. Each leg is formed, at least in part, from one or more spacer elements, and it is possible to vary the number of spacer elements in the leg, and/or it is possible to exchange at least one spacer element for a spacer element of a different height, so that a length of the leg can be varied.

The invention relates to a workpiece support as well as to a workpiece support system.

A workpiece support serves to make one or more workpieces available and to hold them, so that they can be processed in a production station. By means of the workpiece support, the workpieces can be brought to one or more production stations within the framework of the production process and processed there. They can be transported between the production stations and stored in the workpiece supports between the production steps. In the production stations, production steps such as washing, mechanical processing or thermal hardening can be carried out.

The workpiece support comprises a support base, which can be configured in the form of a plate, as well as handles for easier handling. By means of holders, for example arms that project upward, and receptacles, for example baskets, on the support base of the workpiece support, the workpieces can be held in a desired position and grouped. The holders and receptacles can be configured to be changeable with regard to their position, so that the workpiece support can be adapted to the workpieces to be processed and/or to the production station in which the workpiece support is used.

Supports are also used in other areas. DE 603 19 072 T2 shows a stackable support for plants, having arc-shaped contact surfaces for stacking, which can be removed. US 2009/0 139 890 A1 shows a tray having integrated handles. U.S. Pat. No. 2,747,748 A shows stackable bread carriers, which have handles that can be flipped over. CN 2 09 777 053 U shows a stackable tray having integrated handles. JP 2002-68 194 A shows a rolling pallet, to which an arc-shaped handle for pushing and pulling can be attached.

The task arises of making an alternative workpiece support available.

This task is accomplished by means of a workpiece support and a workpiece support system in accordance with the independent claims.

A workpiece support is provided, having a support base and at least one height-adjustable handle, which comprises a cross-piece and two legs, and is detachably secured to the support base, wherein each leg is formed, at least in part, from one or more spacer elements, and wherein the number of spacer elements in the leg can be changed and/or at least one spacer element can be replaced with a spacer element of a different height, so that a length of the leg can be varied.

The support base serves for holding the workpieces, and can be configured, for example, in plate form or basin form with edge regions that project upward. It is advantageous if two handles are arranged on opposite edge regions of the support base, so as to facilitate handling of the workpiece support, in that it can be held by the handles.

The handle comprises the cross-piece by which the handle is held. It is arranged at a distance from the carrier base, by means of the legs, so that at least a center region of the cross-piece can be enclosed by a hand when it is held. The cross-piece has an elongated shape. It can have a rectangular basic shape or can have a rounded cross-section in the center region, so that it can be held more easily. The length of the cross-piece can correspond to a side length of the support base to which it is attached, or it can be shorter. Two legs project from the outer edge regions of the cross-piece, toward the support base, which legs advantageously have the same length.

It is advantageous if they run at a right angle relative to the cross-piece and the support base. The legs have a cylindrical shape having a rectangular, round or oval cross-section, for example.

A handle height above the support base is determined by the leg length. It is advantageous if both legs of the handle have the same length, and both handles on the support plate have the same handle height. The leg length depends on the number of spacer elements in the leg. By means of changing the number of spacer elements in the leg, the leg length, and thereby also the handle height, can be changed. The number can be reduced until no spacer elements are provided in the leg any longer, and the cross-piece makes contact with the support base.

The leg length can be varied not only by the number of spacer elements, but rather also by means of their height, so that a spacer element can be replaced by a taller one or a flatter one, so as to change the handle height. Spacer elements of different heights can be provided in the leg.

It is advantageous if the workpiece support comprises at least one securing means, which connects the handle to the support base, so that the spacer elements form at least parts of the legs. The securing means can run in the leg between the cross-piece and the support base, so that it clamps the spacer elements between the cross-piece and the support base. In one embodiment, the securing means comprises a component having an inside thread and a component having an outside thread, which can be joined together by means of a screw connection. The components can be a screw and a screw nut, wherein a screw head of the screw is arranged on the underside of the support base and the screw nut is arranged on the top side, on the cross-piece, or vice versa. Instead of a screw nut, a cap nut can be provided. The spacer elements, in the case of such securing, advantageously have a passage hole through which the securing means, in particular the screw, runs, so that during assembly of the handle components, it also aligns the spacer elements. Alternatively, a bolt having an inside thread can also be provided, which runs from the cross-piece through the spacer elements, and into which a short screw engages on the support base.

In one embodiment, the cross-piece is configured in one piece and has leg attachments, the base surface of which corresponds to a base surface of the spacer elements. Leg attachments are end region of the cross-piece that project downward, which regions have been set down on the spacer elements. If such a cross-piece is secured to the support base without spacer elements, the center region does not touch the support base. The spacer elements advantageously have a cylindrical shape with the same base surface, which is in the form of a rectangle, for example, so that during assembly, although height and number are relevant, the sequence in which they are stacked in the leg is not.

In one embodiment, the cross-piece has passage holes, each with a depression at a top side of the handle. The passage hole and the depression are configured in such a manner that the securing means can be mounted countersunk into the cross-piece. This reduces the risk of injury at the top side of the handle, caused by securing means that project upward. When using a screw and a screw nut as the securing means, the depression is configured in such a manner that either the screw head is countersunk or the screw nut is countersunk. In the latter case, it is advantageous if the screw end also does not project beyond the top side of the cross-piece.

In one embodiment, the depression is configured in such a manner that a locking means that projects upward out of the handle can be inserted into it. The locking means can engage, for example, into a stacked further workpiece support or engage into a support set onto the handles, in order to align and hold these components.

It is advantageous if the cross-piece and the spacer elements are formed from plastic, which is accompanied by low weight. The support base can be formed essentially from plastic or essentially from metal, for example stainless steel, wherein the material selection and the support base configuration depends on the use requirements. Nevertheless, other materials can be provided, to a slight extent, on the support base.

The workpiece support is joined together from components of a workpiece support system. The workpiece support system comprises a support base, two cross-pieces, and a plurality of spacer elements, which can be joined together with the workpiece support using two height-adjustable handles. The handles each comprise one of the cross-pieces and two legs, wherein each leg can be formed, at least in part, from one or more of the spacer elements. The handle height depends on the number and height of the spacer elements inserted into the leg.

It is advantageous if the workpiece support system comprises a plurality of securing means having different lengths, wherein the securing means connect the handles to the support base and the lengths correspond to different numbers and/or heights of spacer elements in the leg, in such a manner that the securing means can be mounted on the cross-piece in a countersunk manner. For different combinations of spacer elements in the leg, securing means having a suitable length are provided, in each instance, so that it can be mounted in the cross-piece in a countersunk manner, for a combination of a given number of spacer elements having predetermined same or predetermined different heights.

For more degrees of freedom during joining of a workpiece support, the plurality of spacer elements comprises spacer elements having different lengths. In addition or alternatively, a further support base can be provided, wherein the support bases differ.

In the following, some exemplary embodiments will be explained in greater detail, using the drawing. The figures show:

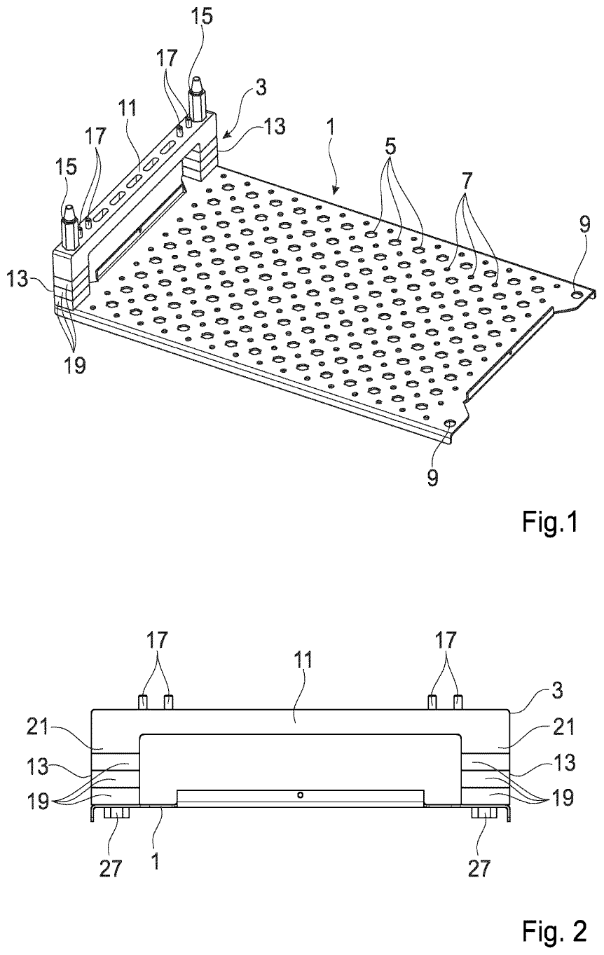

FIG. 1 an exemplary embodiment of a workpiece support in a three-dimensional view,

FIG. 2 the workpiece support in a side view,

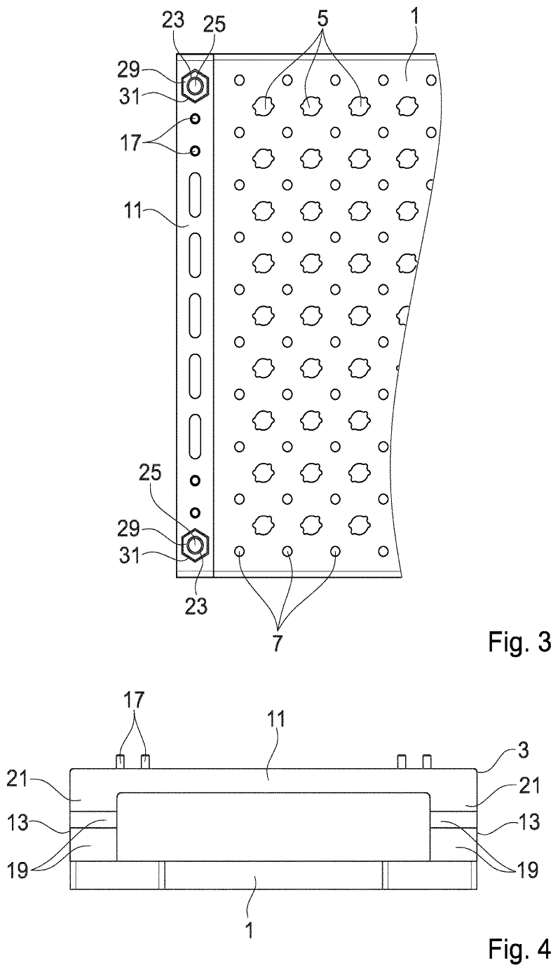

FIG. 3 a detail view of the workpiece support in a top view,

FIG. 4 a further exemplary embodiment of a workpiece support in a side view, and

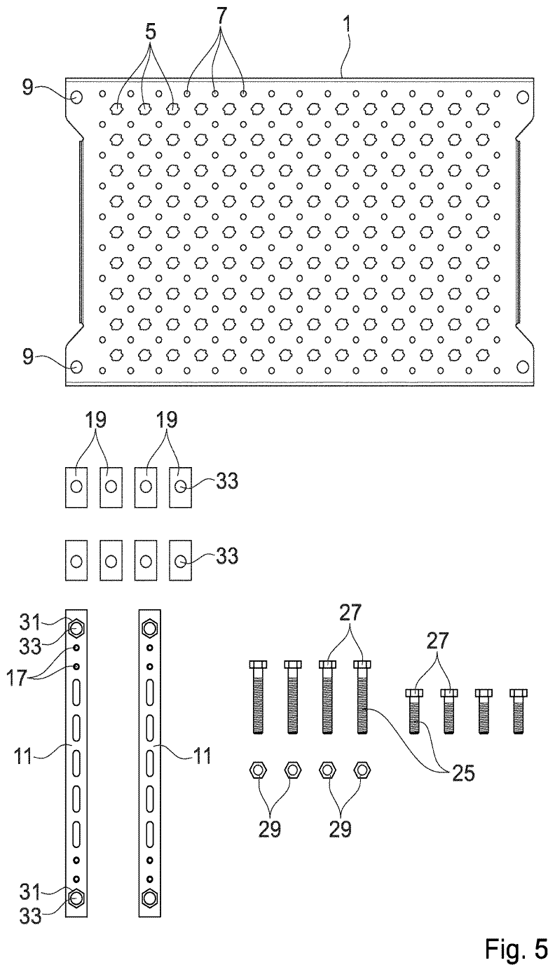

FIG. 5 an exemplary embodiment of a workpiece support system in a top view.

In the figures, components that are the same or functionally equivalent are given the same reference numbers.

FIG. 1 shows an exemplary embodiment of a workpiece support in a three-dimensional view, which comprises a support base 1 and a handle 3. Usually, two handles 3 are provided on opposite outer sides of the support base 1. However, for the sake of clarity, only one of the handles 3 is shown.

The support base 1 is configured so that holders and receptacles, for example baskets, can be detachably connected to it. For this purpose, the support base 1 has a plurality of first and second recesses 5, 7, which pass through and are arranged in a raster shape, in each instance. The holders and receptacles can be clamped into the first recesses 5. The second recesses 7 essentially serve for alignment and locking in place of the clamped holders and receptacles. In this exemplary embodiment, the support base 1 is configured to be metallic. It has edges folded downward and upward on its longitudinal and broad sides, so as to increase the stability.

On the broad sides, the handles 3 project upward; they are releasably secured on the support base 1. For this purpose, passage holes 9 are provided in the corner regions of the support base 1, through which the securing means 23 for the handles 3 can pass.

The handle 3 comprises a cross-piece 11 that runs essentially parallel to the support base 1 and at a distance from it. The cross-piece 11 has an elongated, block-shaped basic shape. The handle 3 furthermore comprises legs 13 that project downward toward the support base 1, at end regions of the cross-piece 11, which legs run essentially perpendicular between the cross-piece 11 and the support base 1, and are configured to have a cylindrical shape with a rectangular cross-section.

On the top side of the handle 3, locking means 15 are provided in the end regions of the cross-piece 11, which means project upward beyond the handle 3, and are positioned in depressions 31 of the handle 3. In this exemplary embodiment, they are configured as hexagonal pins having a conical tip, which can engage into a support plate or a further workpiece support that is stacked on the workpiece support, which plate or support can be positioned on the workpiece support, so as to align the support plate or the further workpiece support and hold it in its position. The locking means 15 are inserted into the depressions 31 and have an inside thread. The locking means 15 is part of the securing means 23 for the handle 3. The securing means 23 furthermore comprises a screw that engages into the inside thread, so that the handle 3 and the support base 1 are clamped in place between the locking means 15 and the screw head. In addition, further locking means 17 are provided on the top side of the handle. These means are configured in one piece with the cross-piece 11, as pegs that project upward on the top side of the cross-piece 11.

FIG. 2 shows the workpiece support from FIG. 1 in a side view. The handle 3 is structured in multiple pieces, and comprises the cross-piece 1 and multiple spacer elements 19 that form the legs 13, at least in part. The spacer elements 19 have the same height in this exemplary embodiment. Both legs 13 have the same length and have the same number of spacer elements 13.

The one-piece cross-piece 11 has leg attachments 21, which extend downward in its end regions and form the legs 13 together with the spacer elements 19. Multiple spacer elements 19 are arranged one on top of the other between the leg attachments 21 and the support base 1. The cross-piece 11 is connected to the support base 1 by way of spacer elements 19. The spacer elements 11 have a block-shaped form, the edges of which can be rounded off. The base surface of the leg attachments 21 corresponds to a base surface of the spacer elements 19, so that the leg attachments 21 and the spacer elements 19, which are arranged one on top of the other, form cylindrical legs 13.

The length of the legs 13 and thereby the height of the handle 3 above the support base 1 depends on the number of spacer elements 19 and their height. In this exemplary embodiment, spacer bodies 19 having different heights can form the legs 3, at least in part.

Securing of the handle 3 takes place by means of a fastening means 23. Two screws 25 that run through the support base 1, the spacer elements 19, and the cross-piece 11 secure the handle 3 on the support base 1, in that a screw head 27 and a screw nut 29 form a clamping connection of the components arranged between them. It is advantageous if the screw head 27 is positioned on the underside of the support base 1, and the screw nut 29 is positioned on the top side of the cross-piece 11. A clamping length between the screw nut 29 and the screw head 27 depends on the number and height of the spacer elements 19 arranged between them, as well as on the cross-piece thickness in this region. Not only the support base 1 but also the spacer elements 19 and the cross-piece 11 have passage holes 9, 33 for the screws 25.

Instead of a screw nut 29 that has a threaded hole that passes through it, a cap nut can be used, which is closed on one side. It reduces the risk of injury and furthermore offers an optically appealing end of the screw connections. It is advantageous if the cap nut is completely countersunk in the cross-piece 11.

Alternatively, a stacking bolt having an inside thread and a screw can be used as a securing means 23. The stacking bolt has a region that projects upward beyond the handle 3, which bolt serves as a locking means 15 and can be structured like the locking means 15 from FIG. 1. The stacking bolt extends beyond the depression 31, in which it sits, through the cross-piece 11 and one or more spacer elements 19. A screw on the support base 1, which is shorter than in the case of the other exemplary embodiments, engages into the inside thread, so that the handle 3 and the support base 1 are clamped between the screw head and the upper region of the stacking bolt.

After being released from the support base 1, the handle 3 can be separated into the cross-piece 11 and spacer elements 19. The handle height depends on the number and height of the spacer elements 19 between the cross-piece 11 and the support base 1.

The handle height can be changed, in other words reduced or increased, by means of removing and additions spacer elements 19 between the cross-piece 11 and the support base 1. The handle height can also be changed by means of replacing spacer elements 19 with spacer elements 19 having a different height. The two measures can be combined. The least handle height occurs if no spacer elements 19 are provided and the leg length corresponds to the length of the leg attachment 21. In the case of a cross-piece 11 without a leg attachment 21, it would lie completely against the support base 1 without any spacers 19.

FIG. 3 shows a detail view of the workpiece support in the handle region, in a top view. This view illustrates securing by means of the screw 25 and the screw nut 29. The passage bore 33 in the cross-piece 11 has a depression 31 in which the screw nut 29 is arranged, so that it does not project. It is advantageous if the shape and size of the screw nut 29 and the depression 31 correspond to one another; in this exemplary embodiment, they are hexagonal. The thread of the screw 25 engages into the screw nut 29 in such a manner that the support base 1, the spacer elements 19, and the cross-piece 11 are held together. The screw length is such that it does not project beyond the top side of the cross-piece and nevertheless engages firmly in the thread of the screw nut 29. If the handle height is changed by means of more or fewer spacer elements 19 or spacer elements 19 having a different height, it is advantageous if a different screw 25 having a suitable length is used, so that it does not project and nevertheless engages securely.

Alternatively, the handle 3 can also be secured by means of a screw/screw nut connection, in which the screw head 27 is arranged on the cross-piece 11, in particular in the depression 31, and the screw nut 29 is arranged on the support base 1. In the case of such an exemplary embodiment, as well, the shape and size of the screw head 217 and the depression 31 can correspond to one another, and the screw head 27 does not project.

In the case of screw/screw nut connections, washers, springs or the like can additionally be provided on the screw head 27 and/or on the screw nut 29.

FIG. 4 shows a further exemplary embodiment of a workpiece support in a side view. To avoid repetition, the description concentrates on differences from the preceding exemplary embodiment.

In this exemplary embodiment the support base 1 is not configured to be completely metallic, but rather is made of plastic, which offers greater freedom in its design. The support base 1 has at least first recesses 5 that pass through. On its underside as well as on the side edges, walls that project downward are provided as stabilization, between the recesses 5, and these are an integral part of the support base 1, which determine the height of the support base 1. The support base 1 also has passage holes 9 for the securing means 23, which are configured as a screw 25 and screw nut 29, in its corner regions, with which means the handles 3 are secured to the support base 1. The screw head 27 is countersunk between the walls.

In this exemplary embodiment, the spacer elements 19 have different heights. However, the greater height is a multiple of the lesser height, so that the higher spacer element 19 can be replaced with flatter spacer elements 19. In this way, the legs 13 can comprise a different number of spacer elements 19 at the same height.

FIG. 5 shows components of an exemplary embodiment of a workpiece support system in a top view. The workpiece support system comprises a support base 1, a plurality of spacer elements 19, and a plurality of fastening means 23 having different lengths, from which a workpiece support having a changeable handle height can be joined together. The securing means 23 are screws 25 and screw nuts 29, wherein the screw lengths correspond to different numbers of spacer elements 18 in the legs 13, in such a manner that the securing means 23 can be mounted on the cross-piece 11 in a countersunk manner. The screws 25 having different lengths can be put together with a number of spacer elements 19, which number depends on the screw length, so that although they allow clamping of the components between the screw head 27 and the screw nut 29, they do not project. In this way, handles 3 having different handle heights can be put together from the components of the workpiece support system.

The workpiece support system shown as an example comprises a support base 1. It is metallic and has raster-shaped recesses 5, 7. In an alternative workpiece support system, multiple different support bases 1 are provided. The workpiece support system shown as an example furthermore comprises two cross-pieces 11 and eight spacer elements 19 that have the same height, as well as two sets of four screws 25, in each instance, that have the same length, and four screw nuts 29. The screw length of the sets differs. Using the workpiece support system, it is possible to join together handles 3 having legs 13, which comprise either one or two spacer elements 19, and to mount them on the support base 1. When using no spacer elements 19, the screws 15 would project, so that yet another set of screws 25 would be necessary.

The workpiece support system shown comprises support elements 19 having the same height. An alternative workpiece support system comprises support elements 19 having different heights.

The characteristics indicated above and in the claims as well as those that can be derived from the figures can be advantageously implemented both individually and in different combinations. The invention is not restricted to the exemplary embodiments that are described, but can be modified in many ways within the scope of the ability of a person skilled in the art.

### REFERENCE SYMBOLS

1 support base

3 handle

5, 7 recess

9, 33 passage hole

11 cross-piece

13 leg

15, 17 locking means

19 spacer element

21 leg attachment

23 securing means

25 screw

27 screw head

29 screw nut

31 depression

1. A workpiece support having a support bottom (1) and at least one height-adjustable handle (3), which comprises a cross-piece (11) and two legs (13) and is detachably secured to the support base (1), wherein each leg (13) is formed, at least in part, from one or more spacer elements (19), and wherein the number of spacer elements (19) in the leg (13) can be changed and/or at least one spacer element (19) can be replaced with a spacer element (19) of a different height, so that a length of the leg (13) can be varied.

2. The workpiece support according to claim 1,
further comprising at least one securing means (23) that detachably connects the handle (3) to the support base (1).

3. The workpiece support according to claim 2,
wherein the securing means (23) runs between the cross-piece (11) and the support base (1), in the leg (13).

4. The workpiece support according to claim 2,
wherein the securing means (23) comprises a component having an inside thread and a component having an outside thread, which can be joined together by means of a screw connection.

5. The workpiece support according to claim 1,
having multiple spacer elements (19) of different heights, which form the leg (13), at least in part.

6. The workpiece support according to claim 1,
wherein the spacer elements (19) have a passage hole (33) through which the securing means (23) runs.

7. The workpiece support according to one claim 1,
wherein the cross-piece (11) is formed in one piece and has leg attachments (21), the base surface of which corresponds to a base surface of the spacer elements (19).

8. The workpiece support according to claim 1,
wherein the cross-piece (13) has passage holes, each with a depression (31) at a top side of the cross-piece, wherein the passage hole (33) and the depression (31) are configured in such a manner that the securing means (23) can be mounted countersunk into the cross-piece (13).

9. The workpiece support according to claim 8,
wherein the depression (31) is configured in such a manner that a locking means (15) that projects upward out of the handle (3) can be inserted into it.

10. The workpiece support according to claim 1,
wherein the cross-piece (13) and the spacer elements (19) are formed from plastic.

11. The workpiece support according to claim 1,
wherein the support base (1) is essentially formed from plastic or essentially to be metallic.

12. A workpiece support system comprising a support base (1), two cross-pieces (11), and a plurality of spacer elements (19) which can be joined together with the workpiece support using two height-adjustable handles (3), wherein the handles (3) each comprise one of the cross-pieces (11) and two legs (13), and wherein each leg (13) can be formed, at least in part, from one or more of the spacer elements (19).

13. The workpiece support system according to claim 12,
wherein the plurality of spacer elements (19) comprises spacer elements (19) of different heights.

14. The workpiece support system according to claim 12, further comprising a plurality of securing means (23) having different lengths, wherein the securing means (23) are configured to connect the handles (3) to the support base (1), and the lengths correspond to different numbers and/or heights of spacer elements (19) in the leg (13), in such a manner that the securing means (23) can be mounted on the cross-piece (11) in a countersunk manner.

15. The workpiece support system according to claim 12, further comprising a further support base (1) that differs from the support base (1).
